(19) United States
(12) Patent Application Publication
(10) Pub. No.: US 2009/0271387 A1
(43) Pub. Date: Oct. 29, 2009

(54) Extraction Method of Interview Relation by Optimal Condition and Record Medium Recording Thereof

(75) Inventor: Woong-Jin Lee, Seoul (KR)

Correspondence Address: Ballard Spahr Andrews & Ingersoll, LLP, SUITE 1000, 999 PEACHTREE STREET, ATLANTA, GA, 30309-3915, US

(73) Assignee: SUNOO CO., LTD., Seoul (KR)

(21) Appl. No.: 11/919,389

(22) PCT Filed: Apr. 24, 2006
(86) PCT No.: PCT/KR2006/001528

§ 371 Date: Mar. 17, 2008

(30) Foreign Application Priority Data
Apr. 28, 2005 (KR) 10-2005-0035384

(51) Int. Cl. G06F 17/30; G06F 21/00; G06F 7/00

(52) U.S. Cl. 707/5; 726/4; 707/104.1; 707/E17.017; 707/E17.044

(57) ABSTRACT

A method of selecting the most suitable partner for a date for the purpose of marriage and a recording medium storing the method are provided. A system for arranging the date comprises a member client management unit for managing registration of clients, an account unit for managing membership fees and usage fees, a security authorization unit for security authorization of a client, if necessary, a match calculating unit for performing calculations to select the most suitable partner, a statistical database for storing and recording various statistical data required for the calculations, an input/output unit inputting and outputting statistical data and data required for operating a server 11 a marriage consultancy, and the server 11 for providing information on marriage. The system enables the most suitable partner to be selected using a status index table indicating an indexed social and economic status, a physical attraction index table indicating an indexed appearance and physique, a home environment table indicating indexed wealth of parents, incomes, and educational backgrounds of siblings, and a database of registered member clients who have gotten married.

### TECHNICAL FIELD

The present invention relates to a method of selecting the most suitable partner for a date for the purpose of marriage, in which various indexes are combined to yield a partner with whom marriage is most probable.

### BACKGROUND ART

Various efforts have been made to improve the success rate of matchmaking. A range of systems and methods have been suggested and tried as companies emerged to arrange dates between men and women for the purpose of marriage and remarriage. For example, various methods and systems on web sites connected to communication networks have been developed and utilized to arrange dates. In particular, development in the field of computers and information technology has enabled dates to be arranged by extracting partners based on principles of traditional Oriental fortune-telling, astrology, and peoples' self-declared traits and preferences.

Generally, a marriage consultancy provides services by arranging dates and profiting from the membership fees of member clients looking for a spouse, or from a commission received when a date successfully results in marriage. Here, finding for member clients a suitable partner for marriage on the first date is of primary concern both to the marriage consultancy and its member clients.

Accordingly, marriage consultancies are trying in various ways to put together a database capable of utilizing various statistics and unique extraction methods to make matches that are likely to result in marriage.

Several methods and systems for arranging dates to find a desirable spouse have been proposed. For example, Korean Patent Publication No. 2000-0072701 discloses a system for arranging a date by statistically selecting a likely marriage partner. The method includes receiving information on a member client and desired conditions through a web site, confirming personality traits and preferences of each member client to provide a optimal date service, utilizing research and statistics on matchmaking, marriage, and divorce to find the best dates for member clients, and using a database storing data on prospective partners' personal preferences, statistical intellectual compatibility, marital compatibility according to traditional beliefs and fortune-telling, personal values and philosophy, life style, etc.

### DISCLOSURE OF INVENTION

### Technical Problem

It is apparent that success rate in finding a marriage partner can be increased by employing a statistical approach. However, methods such as described above may fail to make the best match depending on how data is utilized, a procedure for extracting data, a method of assigning weights, etc. Failure to make a good match may erode member clients' trust in the system and lower the efficiency of the business as dates are repeatedly arranged for the same member clients. Also, inefficiency of an operating server 10 in selecting the most suitable partner translates into increase in hours of operation of the server 10, load on a computer system, and required manpower.

### Technical Solution

One aspect of the present invention provides a method of selecting the most suitable partner for a date for the purpose of marriage, and a recording medium for storing the same, the method capable of rapidly selecting a likely marriage partner using a database compiling experience accumulated by the inventor, who has run a marriage consultancy for several years, and statistics on couples who successfully got married.

### ADVANTAGEOUS EFFECTS

As described above, the method of selecting the most suitable partner for a date for the purpose of marriage, and the recording medium storing the same, of the present invention have the following advantages:

Firstly, a system and method enable a client to meet his/her ideal partner by receiving personal information from the member client, classifying the client in consideration of his/her social and economic situation, and receiving the client's requirements of his/her ideal partner.

Secondly, the system of the present invention provides differentiated fees and services by analyzing individual data such as the client's social and economical data at the beginning of registration. This has the effect of ensuring socially and economically prestigious clients, which is a factor contributing to the marriage consultancy's success and competitiveness.

Thirdly, the present invention has the effect of improving the marriage rate of member clients by selecting a partner for a date with reference to an indexed database of couples who have successfully gotten married. And, while conventional randomized input criteria result in it taking considerable time to select the most suitable partner since numerous member clients are evaluated simultaneously, the present invention has the effect of reducing time consumed in selecting the most suitable partner by sequentially narrowing down the choice of partners.

### BRIEF DESCRIPTION OF THE DRAWINGS

FIG. 1 illustrates a configuration of a system for selecting the most suitable partner for a date for the purpose of marriage according to an exemplary embodiment of the present invention;

FIG. 2 is a flowchart illustrating member client maintenance and management according to an exemplary embodiment of the present invention;

FIG. 3 is a flowchart illustrating a procedure of member client logging into a server performing the present invention, and handling of membership fees and classification of the member client according to an exemplary embodiment of the present invention;

FIG. 4 is a flowchart illustrating selection of the most suitable partner according to an exemplary embodiment of the present invention; and

FIG. 5 is a flowchart illustrating determination of an order of dates with selected partners according to an exemplary embodiment of the present invention.

### BEST MODE FOR CARRYING OUT THE INVENTION

Hereinafter, exemplary embodiments of the present invention will be described in detail. However, the present invention is not limited to the exemplary embodiments disclosed herein but can be implemented in various modified forms. Therefore, the present exemplary embodiments are provided for complete disclosure of the present invention and to fully inform the scope of the present invention to those of ordinary skill in the art.

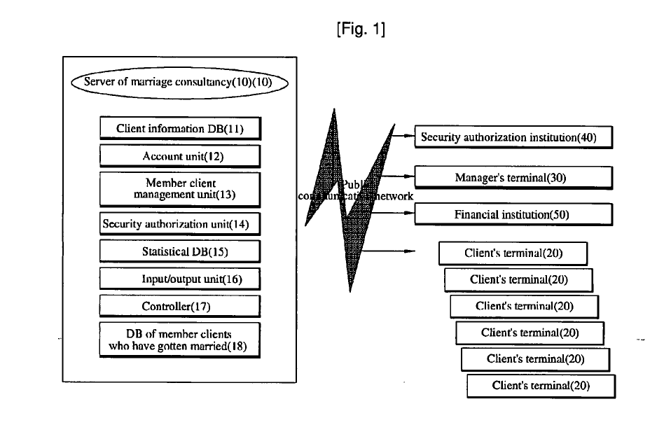

In a method of selecting the most suitable partner for a date for the purpose of marriage according to the present invention, a marriage consultancy operates a server 10 which a client can connect to through a public network. The server 10 is the central component of a system for selecting the most suitable partner for a date for the purpose of marriage according to the present invention, an exemplary embodiment of which is illustrated in FIG. 1.

The server 10 comprises a client information database 11 which stores client information received from a member client who directly connects to the server 10 through the Internet, etc., or from a marriage consultant or letters, a member client management unit 13 managing member registration of a client, an account unit 12 managing membership fees and usage fees, a security authorization unit 14 for security authorization of the member client, if necessary, a match calculating unit performing a calculation to extract a partner for a date for the purpose of marriage, a statistical database 15 storing and recording various databases required for a match calculation, an input/output unit inputting and outputting statistical data, and data required for operating the server 10. And, the server 10 is connected to the member client through the public network and to an external financial institution 50 and an identification institution performing security authorization, if necessary.

The server 10 further comprises a client information database (DB) for managing and storing personal information of a member client to extract an optimal partner with whom marriage is most likely according to analyzing data on couples who have gotten married accumulated by the inventor, a social and economic status index table indicating an indexed social and economic status, a physical attraction index table indicating an indexed appearance and physique, a family background index table indicating indexed wealth of parents, incomes, educational background of siblings, a client marriage probability table listing a probability of the client getting married according to the client's basic information, and a marriage DB storing conditions regarding member clients who have gotten married.

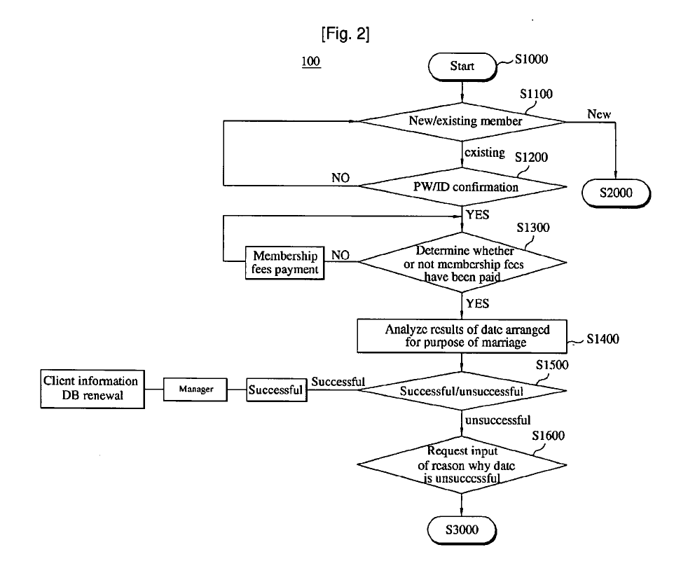

A process of selecting the most suitable partner using a system of a marriage consultancy will now be described with reference to flowcharts illustrated in FIGS. 2 to 5.

FIG. 2 is a flowchart illustrating member client maintenance and management.

Managing a membership fee and storing a result of a date in a database are well-known in the field of the present invention.

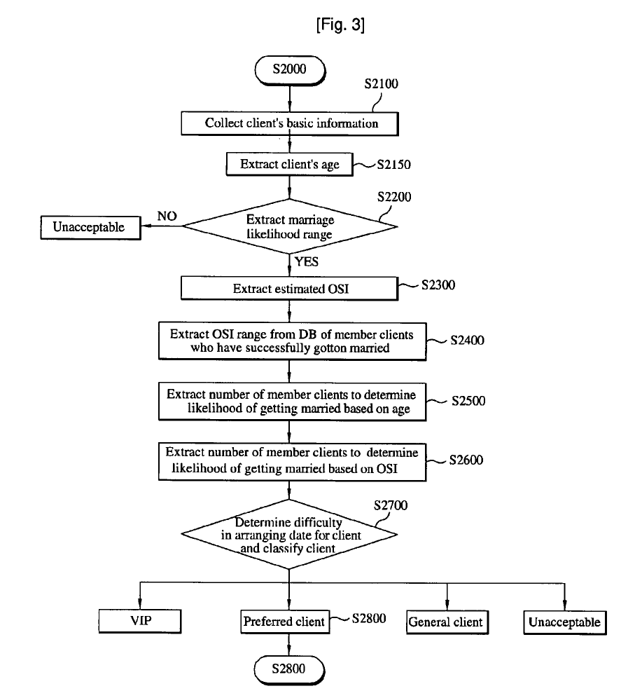

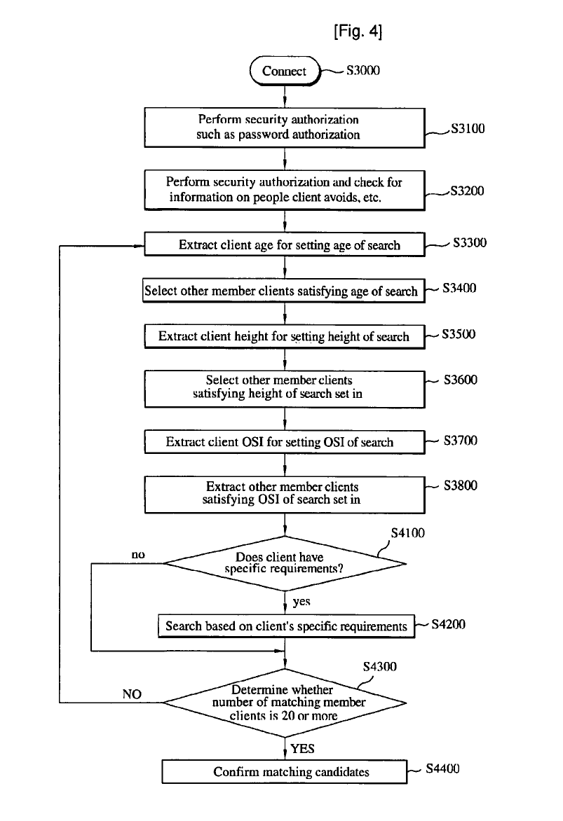

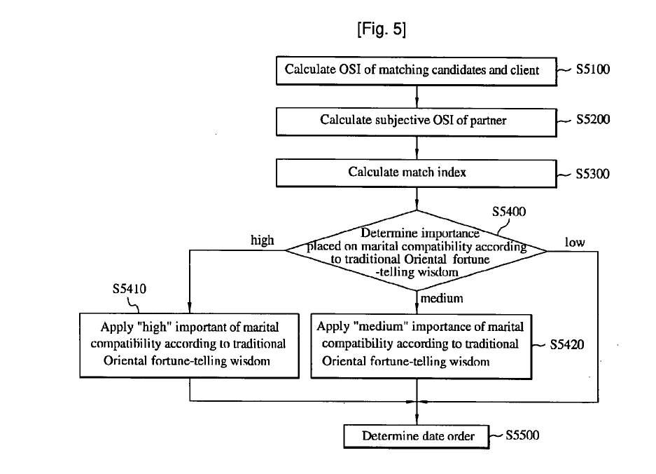

FIG. 3 is a flowchart illustrating a client connecting to the server 10 to classify a membership fee and grade of the client by analyzing the client's basic characteristics, FIG. 4 is a flowchart illustrating selection of the most suitable partner, and FIG. 5 is a flowchart illustrating determination of an order of dates arranged with selected partners.

FIG. 2 is a flowchart illustrating member client maintenance and management, and in particular, the well-known case of managing membership fees and storing the number of the dates arranged and results of dates in a DB. The procedure comprises connecting to a server 10 of a marriage consultancy by a client who wants a date (s1000), identifying the member client by means of password, which is a well-known method for identifying a member client in this field, to confirm whether the client connecting to the server 10 is an existing or a new client and inducing the client to register if he/she is not an existing member client (s1100 and s1200), and confirming whether membership fees are paid and informing an existing member client of unpaid membership fees, which is well-known in this field and thus will not be described in detail, and performing an accounting procedure in connection with a financial institution and an identification institution.

Also, the server 10 confirms the database of the client, and transmits a question form having a list of questions or a check list to the client to confirm whether or not a date is currently arranged. The client inputs a result of a date, or a marriage consultant confirms the data input related to the client through a wired/wireless telephone interview or face-to-face consulting, thereby confirming whether or not the arranged date was successful. Then, the consultant records the result in the client information DB and renews the DB. Also, if the existing member client does not continue date a certain partner, the procedure of selecting the most suitable partner (s3000), which will be described later, is repeated to arrange another date based on another selected partner (s1500 and s1600).

The step of confirming whether the client is a new or existing member client includes a procedure for classifying the client according to his/her likelihood of marriage-based on the client information as illustrated in FIG. 2.

When the client is a new member, for the purpose of analyzing the likelihood of the client getting married, the server 10 receives a predetermined form set in the present invention or personal information of the client from sites, etc., generally operated on a membership basis. Such a form and method are well-known in the field of the invention and thus will not be described in detail.

To extract indexes set by an operator of the server 10, the client inputs his/her educational background, origin, high school, university or postgraduate institution, place of work, annual salary, duty, major, physique, height, weight, family wealth, parents' educational backgrounds, whether he/she is from a broken family, siblings' educational backgrounds. This is all in addition to simple information such as the client's address, name, occupation, and characteristics that the client avoids regardless of other conditions, for example, a certain religion, race, region, surname, etc. The client also receives information on a desirable partner. The information may be input through a terminal connected to the server 10, through other wired/wireless means, by mail, or the consultant may input results of consulting to assemble the client information.

The data input to analyze the likelihood of the client getting married is not limited to the items as listed above, and data may be selectively added or omitted as necessary.

After performing the step of collecting the client's basic information for indexing (s2000), the information is databased for each client and stored in the client information DB 11. Then, a controller 17 of the server 10 reads the data corresponding to the client and selects the client's age in the client information DB 11 (s2150). Referring to data indicating marriage rates of member client of various ages with partners of the client's age in the marriage DB 18, i.e., referring to a probability distribution chart indicating the marriage probability versus age of member clients who have gotten married to someone of the target client's age, the controller 17 then selects an age range within which the marriage rate is 70% or more (s2200).

In addition, the server 10 calculates an estimated objective spouse index (OSI) of the client (s2300).

In the above description, the order in which s2200 and s2300 are performed may be changed or both steps may be performed simultaneously.

The OSI is a linear combination of a social and economic status index (SESI) based on educational background and occupation set by the present inventor with reference to the client information DB, a physical attraction index (PAI) indicating an indexed appearance and physique, and a family background index (FBI) indicating parents' wealth, educational background, information on whether the date candidate is from a broken family, educational background of siblings, home environment, etc. The OSI is given by the following equation:

OSI=SESI*weight 1+PAI*weight 2+FBI*weight 3

(Weights applied to each index may be the same or may be selectively varied according to the subject's sex or a client's request or experience).

To obtain the OSI, the present inventor uses data tables made based on a database of statistics on member clients who successfully got married and experience. Also, a weight is assigned to each index in the process of adding up each table. Here, the weights are determined according to the inventor's experience or with reference to the database of member clients who successfully got married.

Each index table for extracting the OSI is shown below. These tables are merely examples and may be altered as deemed appropriate.

A score table for educational background for extracting the SESI index is divided into university graduates and high school graduates in Korea, and scores ranging from 20 to 100 are allotted according to school and department.

TABLE 1

| Name of school (department) | Score |
|---|---|
| Department of Medicine, A1 University | 100.0 |
| Department of Oriental Medicine, A2 University | 99.9 |
| . . . | |
| Z1 High School | 20.0 |

In an occupational influence table for extracting the SESI index scores ranging from 50 to 100 are allotted to, for example, 200 occupations.

TABLE 2

| Occupation | Score |
|---|---|
| high ranking official, 3^{rd} grade or higher | 100.0 |
| judge | 99.95 |
| . . . | |
| | 50.0 |

In an income index table for extracting the SESI index, scores ranging from 20 to 100 are allotted to 30 stages in annual income. Also, different standards are applied to men and women.

TABLE 3

| Men | | Women | |
|---|---|---|---|
| Annual salary | Score | Annual salary | Score |
| 11 million won or less | 20.00 | 11 million won or less | 20.00 |

. . .

| | | | |
|---|---|---|---|
| 98 million won or more | 100.00 | 67 million won or more | 100.00 |

Facial appearance, weight, physique, and a general appearance grade (reflecting facial appearance and physique on a first impression basis), for extracting the PAI index, are classified into 135 stages based on height. Scores from 30 to 100 are allotted to each stage. Naturally, different standards are applied to men and women.

TABLE 4

| Men | | Women | |
|---|---|---|---|
| 164 cm or less-51 kg | 41.6 | 150 cm or less-35 kg | 37.4 |
| or less-skinny type- | | or less-skinny type- | |
| appearance fine | | appearance fine | |
| 164 cm or less-51 kg | 30.8 | 163~164 cm or less-51 kg | 30.4 |
| or less-skinny type- | | or less-skinny type- | |
| appearance poor | | appearance poor | |

. . .

| | | | |
|---|---|---|---|
| 177~179 cm or less-64~67 | 98.02 | 163~164 cm or less-46~51 | 94.8 |
| kg or less-normal type- | | kg or less-slim type- | |
| appearance fine | | appearance fine | |

. . .

Wealth of parents, for extracting the FBI index, is divided into 10 stages from 100 million won or less to 5,000 million won or more, and each stage is given a score from 20 to 100 points.

TABLE 5

| Category | Score |
|---|---|
| 5,000 million won or more | 100.0 |
| 2000~5000 million won | 94.40 |
| . . . | |
| 100 million won or less | 20 |

Social status of parents indicating educational background and incomes of the parents, for extracting the FBI index, is classified into 6 stages by giving 6:4 weight to the father's educational background and incomes versus the mother's, and each stage is given a score of 30 to 100 points.

Whether or not the candidate is from a broken family, for extracting the FBI index, is classified into 60 stages in consideration of the reason and time of the family break up, and current conditions. Also, each stage is given a score of 20 to 100 points, 100 point indicating a family that is not broken.

Social status of siblings for extracting the FBI index is determined by adding up educational background indexes of siblings, including the candidate himself/herself, who are at least nineteen years of age, and then dividing the result by the number of siblings.

The home environment based on a response, for extracting the FBI index, is classified into 5 stages such as very happy, unhappy, etc., and each stage is given a score of 25 to 100 points.

As described above, the score is extracted from each element of each index to extract the OSI, weights are assigned according to sex, etc., in the course of adding up the score of each index, and the OSI is extracted by assigning a weight to each index, if necessary.

The weights are assigned according to statistics and experience of the present inventor. Integration of the experience of an individual user with the present invention is not considered as a departure from the technical concept of the present invention, but merely a change in a numerical value. The present invention is not limited to the above-described embodiment and various modifications can be made without departing from spirit and scope of the present invention.

An OSI range of member clients who have successfully gotten married with a partner of the client's estimated OSI is obtained from the marriage DB by selecting a range corresponding to 60% of the total width of an OSI-based probability distribution, based on the client's estimated OSI (s2400).

Then, the server 10 determines a number of prospective partners for a client by applying a possible age range for marriage obtained from the constructed client information DB in s2200 (s2500).

Next, to determine the client's marriage prospects, the server 10 narrows down the number of prospective partners determined in s2005 to only those who fall within the OSI range calculated in s2400 (s2600).

Next, the client is classified according to a degree of difficulty in recommending the client (s2700). When the number of prospective partners remaining in s2600 is 200 or more, the client is classified as a VIP, when the number is from 100 to 199, the client is classified as a preferred client, when the number is from 30 to 99, the client is classified as a general client, and when the number is 29 or less, the client is classified as unacceptable.

The server 10 informs the client of the result of classification in s2700, privileges, advantages and disadvantages related to grade of the client and the likelihood of the client getting married, number of different dates to be arranged, and registration fees according to the grade of the client, etc. The server 10 also performs an account procedure to settle payment of the registration fees, which is well-known in this field and thus will not be described in detail.

Further, a member client qualification is granted to a client who resisters in the above step of registration, and personal information is understood through an interview with the client, documents, or via the Internet, etc., for the purpose of managing the member's personal affairs. At this time, the data input is stored in the client information DB.

Also, in the step of inputting the client information or after the client registers, the server 10 receives personal information on what level of importance the client places on marital compatibility according to traditional Oriental fortune-telling beliefs, etc., which is described later, and stores the information in the client information DB.

While the client information DB is used to determine whether a member client is recommendable in the step of determining the degree of difficulty in recommending the client, the particular DB used is optional. For example, the marriage DB may be utilized as an alternative to the client information DB.

A process of selecting the most suitable partner, in which prospective partners are narrowed down to a certain number of matching candidates for the registered member client (the client) when the client wants a date to be arranged or when the marriage consultancy arranges a date, will now be described with reference to FIG. 5.

A marriage consultant connects to the server 10 to arrange a date for a target client (s3000). Next, a member client connects to the server 10 by performing security authorization, such as password authorization (s3100). Step s3100 is not performed when the member client is connecting only to register his/her information.

If information on people the client tries to avoid, for example, a specific religion, region, surname, nationality, etc., is detected in the client information DB of the corresponding client when the client's name is input, the search is narrowed down to only member clients in the member client DB who do not match the information on people that the client tries to avoid (s3200).

Next, an age range of a prospective partner is determined by the server 10 searching the marriage DB based on the client's age and selecting an age range corresponding to 30% of the total width of the age-based probability distribution chart, i.e., selecting the age range from the probability distribution chart with 35% of each end of the chart excluded (s3300). Then, the range of prospective partners resulting from s3200 is further narrowed down to only those who fall within the age range determined in s3300 (s3400).

Next, a height range of a prospective partner is determined by the server 10 searching the marriage DB based on the client's height and selecting a height range corresponding to 90% of the total width of the height-based probability distribution chart, i.e., selecting the height range from the probability distribution chart with 5% of each end of the chart excluded (s3500). Then, the range of prospective partners resulting from s3400 is further narrowed down to only those who fall within the height range determined in s3500 (s3600).

Next, an OSI range of a prospective partner is determined by the server 10 searching the marriage DB based on the client's OSI and selecting an OS range corresponding to 30% of the total width of the OSI-based probability distribution chart, i.e., selecting the OSI range from the probability distribution chart with 35% of each end of the chart excluded (s3700). Here, client OSIs are calculated according to personal information on the client obtained during registration or an interview and stored in the client information DB. Then, the range of prospective partners resulting from s3600 is further narrowed down to only those who fall within the OSI range determined in s3700 (s3800).

Subsequently, the server 10 checks whether the client has input any specific prerequisites for his/her partner, such as a certain educational background, region, age, etc. (s4100). Then, the range of prospective partners resulting from s3800 is further narrowed down to only those who satisfy any specific prerequisites of the client found in s4100 (s4200).

Next, the server 10 checks whether the number of prospective partners resulting from s4200 is equal to or greater than a target number set by an operator of the present invention. For example, the target number may set to 20 prospective partners. In this case, when there is determined to be fewer than 20 prospective partners remaining, the range of the probability distribution in s3300 is extended and the above steps are repeated until the number of prospective partners reaches 20 (s4300).

When the number of remaining prospective partners is 20 or more, the server 10 determines them as matching candidates (s4400).

The probability distribution ranges described above are only examples and can be varied as deemed appropriate. The following table is an example showing a probability distribution to which six searches corresponding to s3200 through s4300 are applied. When one run through of the above procedure yields less than 20 prospective partners, the procedure is repeated, as described above. This second repetition is referred to as a second procedure, the third repetition a third procedure, and so on.

TABLE 6

| | | | | Life style | Condition |
|---|---|---|---|---|---|
| Identification | Age (%) | Heigh (%) | OSI (%) | (%) | required |
| First search | 60 | Fixed(95) | 50 | 60 | Fixed |
| Second search | 70 | | 50 | 60 | |
| Third search | 70 | | 60 | 70 | |
| Fourth search | 80 | | 60 | 70 | |
| Fifth search | 80 | | 70 | 80 | |
| Sixth search | 90 | | 80 | 90 | |

Next, the server 10 determines a date order between the client and the matching candidates determined in s4400. This will be described in detail with reference to FIG. 5.

The server 10 calculates a match index indicating suitability of a partner for the member client.

To calculate the match index, first, the client's OSI is calculated by taking a certain weighted combination of SESI, PAI and FAI, wherein the weights may be selected by the client or an operator of the server 10, or set to yield a maximum OSI of 100 (s5100).

Then, the server 10 calculates the OSI of the matching candidates according to the same procedure as in s5100 (5200).

Then, the match index is calculated by giving weights to the client's OSI and the OSI's of the matching candidates and each pair of weighted indexes is summed into one value and divided by two (s5300).

The server 10 sequentially arranges the matching candidates in the order of the match index and ranks their marital compatibility, which involves checking a variable related to marital compatibility in the client DB. That is, the client DB is checked for information related to the client and matching candidate's emphasis on marital compatibility (s5400).

Evaluation of marital compatibility based on traditional Oriental fortune-telling techniques is well-known in the field of the present invention. Such marital compatibility based on traditional Oriental fortune-telling techniques may be calculated by taking a weighted combination of a day of the partner (Ilgan), a day (Ilji), five elements of birth (Napeum), and a year (Yeonji), as follows:

marital compatibility based on traditional Oriental fortune-telling techniques=a day of the partner*0.4+a day*0.2+five elements of birth*0.2

The importance the client and the partner place on marital compatibility based on traditional Oriental fortune-telling techniques is classified into high, medium, and low. Also, the importance the client and the partner place on marital compatibility is further broken down into 16 stages according to the importance of marital compatibility indicated during registration (by both the client and his/her parents) place on marital compatibility into high, medium, and low.

TABLE 7

| Number of | | | | | |
|---|---|---|---|---|---|
| cases | client | | partner | | Importance |
| 1 | 0 | 0 | 0 | 0 | High |
| 2 | 0 | 0 | 0 | * | High |

. . .

| | | | | | |
|---|---|---|---|---|---|
| 15 | * | * | * | 0 | Low |
| 16 | * | * | * | * | Low |

The importance of marital compatibility according to the above table is combined with the calculated marital compatibility based on traditional Oriental fortune-telling techniques. For example, when the importance of marital compatibility is “high” (s5410) and the calculated marital compatibility based on traditional Oriental fortune-telling techniques is 20% or less, the matching candidate is excluded. Then, a date order (date priority) reflecting marital compatibility based on traditional Oriental fortune-telling techniques and the importance the client and partner place of that marital compatibility is determined (s5500).

When the importance of marital compatibility is “medium” (s5420) and the calculated marital compatibility based on traditional Oriental fortune-telling techniques is 20% or less, the matching candidate is excluded if sexual compatibility is also ranked as “poor”. Again, a date order is determined according to the match index in (s5500).

While the invention has been shown and described with reference to certain exemplary embodiments thereof, it will be understood by those skilled in the art that various changes in form and details may be made therein without departing from the spirit and scope of the invention as defined by the appended claims. For example, it will be clear that the date order may be adjusted by the system operator, if necessary, in consideration of urgency, membership fees, and rejection rate, etc. Also, a method of arranging a date by contacting the most suitable partner may be the same as in well-known dating systems and thus will not be described herein.

### INDUSTRIAL APPLICABILITY

A system and method enable a client to meet his/her ideal partner by receiving personal information from the member client, classifying the client in consideration of his/her social and economic situation, and receiving the client's requirements of his/her ideal partner.

The system of the present invention provides differentiated fees and services by analyzing individual data such as the client's social and economical data at the beginning of registration. This has the effect of ensuring socially and economically prestigious clients, which is a factor contributing to the marriage consultancy's success and competitiveness.

The present invention has the effect of improving the marriage rate of member clients by selecting a partner for a date with reference to an indexed database of couples who have successfully gotten married. And, while conventional randomized input criteria result in it taking considerable time to select the most suitable partner since numerous member clients are evaluated simultaneously, the present invention has the effect of reducing time consumed in selecting the most suitable partner by sequentially narrowing down the choice of partners.

1. A method for selecting the most suitable partner for a date for the purpose of marriage using information technology, the method comprising:
logging in to a server for arranging a date to select the most suitable partner, in s3000;
performing security authorization to identify a user as a genuine client, in s3100;
inputting personal information of the client, evaluating information on people the client tries to avoid from a client information DB, and retrieving information on other member clients in a member client DB who do not match the information on people that the client tries to avoid, in s3200;
selecting an age range of prospective partners by searching a marriage DB based on the client's age and selecting an age range based on an age-based probability distribution, in s3300;
selecting from among the other member clients who do not match the information on people that the client tries to avoid only those who fall within the selected age range of prospective partners, in s3400;
selecting a height range of prospective partners by searching the marriage DB based on the client's height and selecting a height range based on a height-based probability distribution, in s3500;
selecting from among the other member clients who do not match the information on people that the client tries to avoid, and who fall within the selected age range of prospective partners, only those who fall within the selected height range of prospective partners, in s3600;
selecting an objective spouse index (OSI) range of prospective partners by searching the marriage DB based on the client's OSI and selecting an OSI range based on an OSI-based probability distribution, in s3700; and
selecting from among the other member clients who do not match the information on people that the client tries to avoid, who fall within the selected age range of prospective partners, and who fall within the selected height range, only those who fall within the selected OSI range of prospective partners, in s3800.

2. The method of claim 1, after selecting from among the other member clients who do not match the information on people that the client tries to avoid, who fall within the selected age range of prospective partners, and who fall within the selected height range, only those who fall within the selected OSI range of prospective partners, further comprising:
determining whether the client has any requirements in selecting the most suitable partner from the client information DB.

3. The method of claim 1, further comprising: determining a number of member clients to be selected.

4. The method of claim 2, further comprising: determining a number of member clients to be selected.

5. The method of any one of claims 1 to 4, further comprising: determining a date order.

6. The method of claim 5, wherein determining the date order comprises calculating a match index.

7. The method of claim 6, wherein calculating the match index comprises:
calculating the OSI of the client, in s5100;
calculating a subjective OSI of a prospective partner, in s5200; and
taking a weighted combination of the client OSI and the prospective partner OSI and dividing the result by two, in s5300.

8. The method of claim 6, further comprising: checking for information concerning importance placed on marital compatibility according to traditional Oriental fortune-telling wisdom, in s5400.

9. The method of claim 8, wherein checking for information concerning importance placed on marital compatibility according to traditional Oriental fortune-telling wisdom comprises:
applying a “high” level of importance on marital compatibility according to traditional Oriental fortune-telling wisdom so that a member client with whom a calculated marital compatibility according to traditional Oriental fortune-telling wisdom is below a predetermined value is excluded from matching candidates, in s5410;
applying a “medium” level of importance on marital compatibility according to traditional Oriental fortune-telling wisdom so that a member client with whom a calculated marital compatibility according to traditional Oriental fortune-telling wisdom is below a predetermined value and sexual compatibility is ranked as “poor” is excluded from matching candidates, in s5420;
applying the importance placed on marital compatibility according to traditional Oriental fortune-telling wisdom to reconstruct a date order, in s5500; and
when the importance placed on marital compatibility according to traditional Oriental fortune-telling wisdom is “poor”, not calculating marital compatibility according to traditional Oriental fortune-telling wisdom and determining the matching candidates according to a match score, in s5500.

10. The method of any one of claims 1 to 4, further comprising: classifying the client according to likelihood of the client getting married on the basis of the client information.

11. A method for arranging a date using information technology, comprising:
collecting basic information on a client, in s2000;
extracting the client's age from a client information DB, in s2150;
extracting ages of registered member clients who have gotten married with reference to a marriage DB, in step 2200;
calculating an estimated objective spouse index (OSI) of the client, in s2300;
estimating an OSI range of member clients who have successfully gotten married with a partner of the client's OSI from the marriage DB by selecting a section of an OSI-based probability distribution based on the client's OSI, in s2400;
selecting a number of member clients within the estimated OS range, in s2600; and
classifying the client according to difficulty in setting up a date for the client based on the selected number of member clients, in s2600.

12. The method of claim 10, wherein classifying the client according to likelihood of the client getting married on the basis of the client information comprises:
collecting basic information on a client, in s2000;
extracting the client's age from a client information DB, in s2150;
extracting ages of registered member clients who have gotten married with reference to a marriage DB, in step 2200;
calculating an estimated objective spouse index (OSI) of the client, in s2300;
estimating an OS range of member clients who have successfully gotten married with a partner of the client's OSI from the marriage DB by selecting a section of an OSI-based probability distribution based on the client's OSI, in s2400;
selecting a number of member clients within the estimated OSI range, in s2600; and
classifying the client according to difficulty in setting up a date for the client based on the selected number of member clients, in s2700.

13. A recording medium storing a method for selecting the most suitable partner for a date for the purpose of marriage using information technology, the method comprising:
logging in to a server for arranging a date to select the most suitable partner (s3000);
performing security authorization to identify a user as a genuine client (s3100);
inputting personal information of the client, evaluating information on people the client tries to avoid from a client information DB, and retrieving information on other member clients in a member client DB who do not match the information on people that the client tries to avoid, in s3200;
selecting an age range of prospective partners by searching a marriage DB based on the client's age and selecting an age range based on an age-based probability distribution, in s3300;
selecting from among the other member clients who do not match the information on people that the client tries to avoid only those who fall within the selected age range of prospective partners, in s3400;
selecting a height range of prospective partners by searching the marriage DB based on the client's height and selecting a height range based on a height-based probability distribution, in s3500;
selecting from among the other member clients who do not match the information on people that the client tries to avoid, and who fall within the selected age range of prospective partners, only those who fall within the selected height range of prospective partners, in s3600;
selecting an objective spouse index (OSI) range of prospective partners by searching the marriage DB based on the client's OSI and selecting an OSI range based on an OSI-based probability distribution, in s3700; and
selecting from among the other member clients who do not match the information on people that the client tries to avoid, who fall within the selected age range of prospective partners, and who fall within the selected height range, only those who fall within the selected OSI range of prospective partners, in s3800.

14. A method for arranging a date using information technology, comprising:
logging in to a server for arranging a date to select the most suitable partner, in s3000;
performing security authorization to identify a user as a genuine client, in s3100;
evaluating information on people the client tries to avoid from a client information DB, and retrieving information on other member clients in a member client DB who do not match the information on people that the client tries to avoid, in s3200;
selecting an age range of prospective partners by searching a marriage DB based on the client's age and selecting an age range based on an age-based probability distribution, in s3300;
selecting a height range of prospective partners by searching the marriage DB based on the client's height and selecting a height range based on a height-based probability distribution, in s3500; and
selecting an objective spouse index (OSI) from the client information DB, in s3700.
